(19) United States
(12) Patent Application Publication
(10) Pub. No.: US 2011/0156566 A1
(43) Pub. Date: Jun. 30, 2011

(54) LED LAMP

(75) Inventors: CHIN-CHUNG CHEN, Tu-Cheng (TW); SHI-YU SONG, Shenzhen City (CN); ZHONG-QING WANG, Shenzhen City (CN)

(73) Assignees: Fu Zhun Precision Industry (Shen Zhen) Co., Ltd., Shenzhen City (CN); Foxconn Technology Co., Ltd., Tu-Cheng (TW)

(21) Appl. No.: 12/723,710

(22) Filed: Mar. 15, 2010

(30) Foreign Application Priority Data
Dec. 25, 2009 (CN) 200910312284.7

(51) Int. Cl. H01J 61/52; H01J 5/48

(52) U.S. Cl. 313/46; 313/318.01

(57) ABSTRACT

An LED lamp includes a connecting member and an LED module. The connecting member electrically connects with a power source. The LED module threadedly engages with and electrically connects to the connecting member.

### BACKGROUND

1. Technical Field

The present disclosure relates to LED (light emitting diode) lamps, and more particularly to an LED lamp having a low energy consumption.

2. Description of Related Art

The conventional light sources, such as fluorescent lamp, halogen lamp and incandescent lamp need large power consumption. It is environmentally unfriendly and energy consumptive.

It is thus desirable to provide an LED lamp which can overcome the described limitations.

### BRIEF DESCRIPTION OF THE DRAWINGS

FIG. 1 is an assembled view of an LED lamp according to an embodiment of the present disclosure.

FIG. 2 is an exploded view of the LED lamp of FIG. 1.

FIG. 3 is an inverted view of FIG. 2.

FIG. 4 is a cross-sectional view of the LED lamp of FIG. 1, taken along line IV-IV thereof.

### DETAILED DESCRIPTION

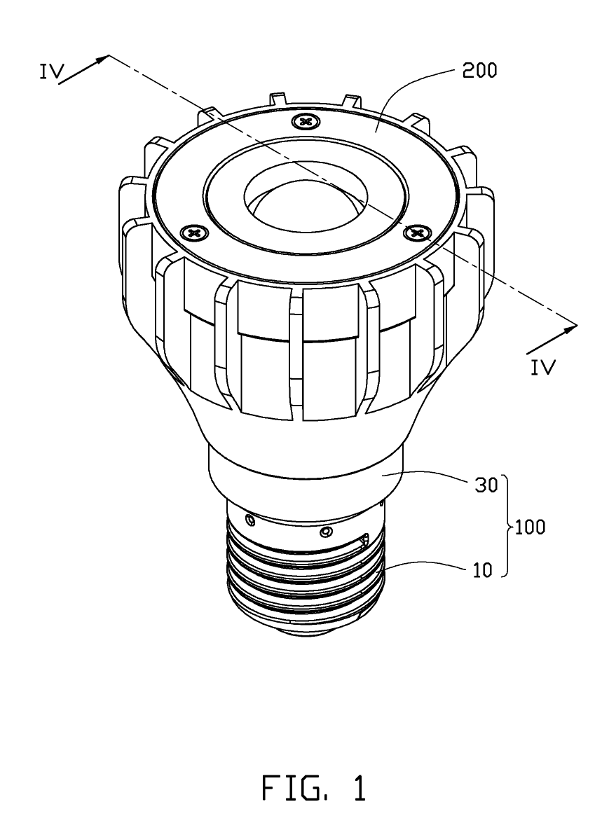

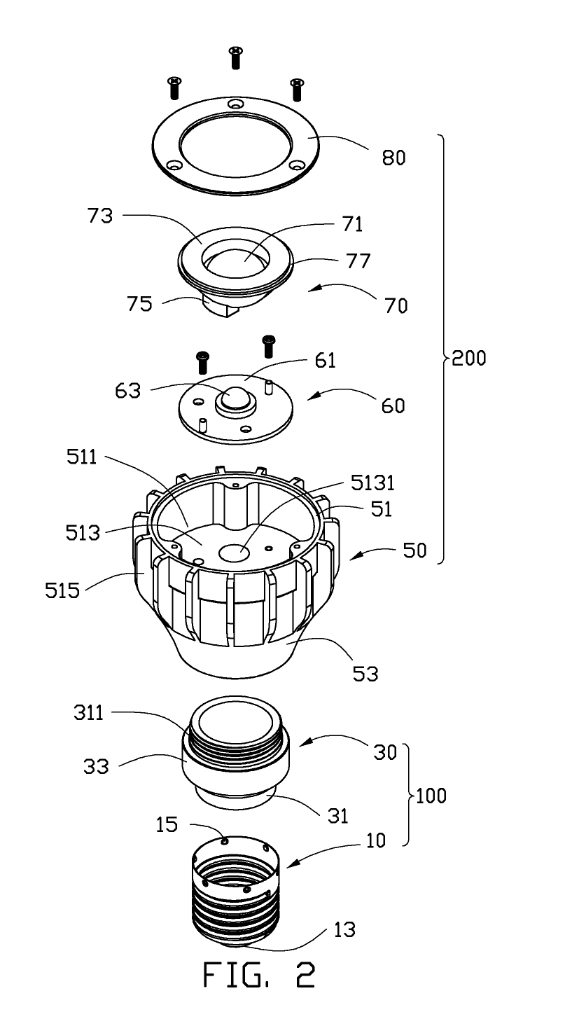

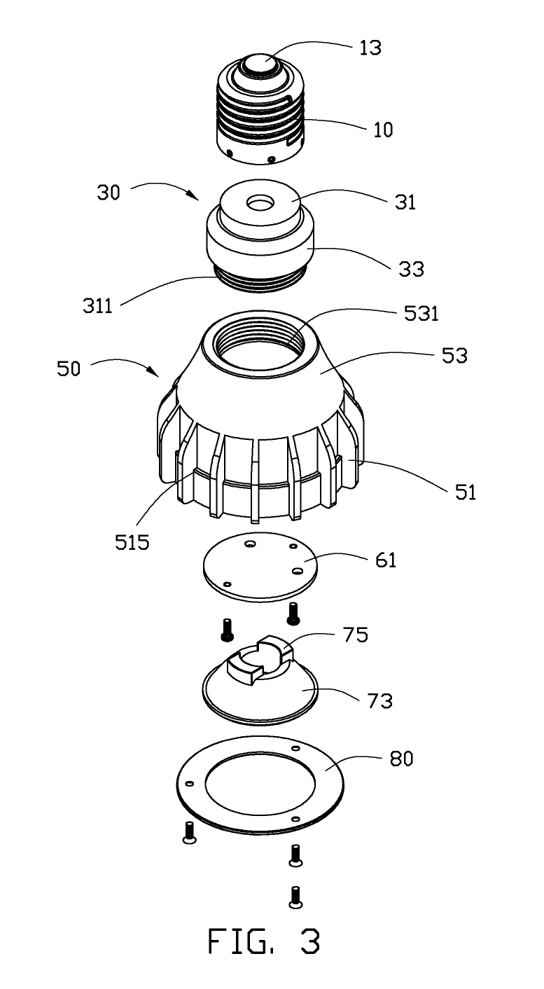

Referring to FIGS. 1-3, an LED lamp according to an embodiment includes a connecting member 100 for electrically connecting a power source (not shown) and an LED module 200 engaging with the connecting member 100. The connecting member 100 includes a connector 30 and a holder 10 engaging with a bottom end of the connector 30. The holder 10 is configured for screwing into a socket (not shown) for electrically connecting the power source. The LED module 200 includes a supporting member 50 engaging with a top end of the connector 30, an LED unit 60 received in the supporting member 50, a lens 70 mounted on the supporting member 50 and covering the LED unit 60, and a pressing ring 80 pressing the lens 70.

The holder 10 is a hollow tube with the bottom end thereof being closed. A metallic patch 13 is formed on an outside of the bottom end of the holder 10. The metallic patch 13 functions as a positive electrode and a threaded periphery (not labeled) of the holder 10 functions as a negative electrode to electrically connect the power source to drive the LED unit 60 to lighten. The holder 10 is a standard element, so the LED lamp can be directly connected to a standard socket matching with the standard holder 10 to electrically connect with the power source. Thus, the LED lamp of the present disclosure can replace the traditional incandescent bulb and compact fluorescent bulb. A plurality of protruded points 15 are formed on an inner surface of the top end of the holder 10. The protruded points 15 are evenly arranged along a circumferential direction of the holder 10.

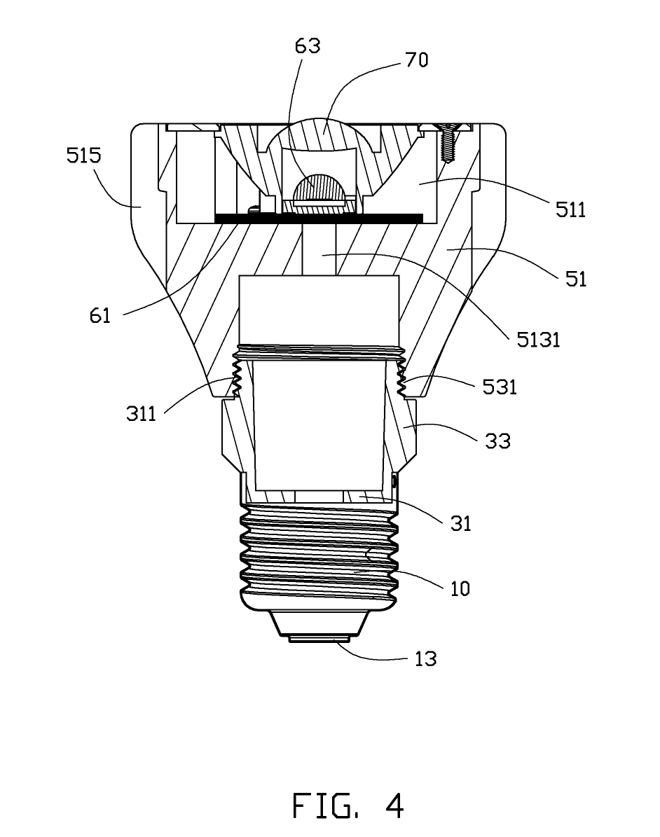

Referring also to FIG. 4, the supporting member 50 is made of aluminum, copper or alloy thereof. The supporting member 50 includes a circular supporting plate 513, a hollow, cylinder-shaped heat dissipating portion 51 extending upwards from an outer periphery of a top side of the supporting plate 513, and a hollow, cone-shaped extending portion 53 extending downwardly from an outer periphery of a bottom side of the supporting plate 513. An outer diameter of the extending portion 53 axially decreases from a top end to a bottom end of the extending portion 53, while an inner diameter of the extending portion 53 is constant. The supporting plate 513 and the heat dissipating portion 51 cooperatively form a receiving chamber 511 to receive the LED unit 60 therein. A central portion of the supporting plate 513 defines a through hole 5131 to allow wires (not shown) extending therethrough to electrically connect the holder 10 and the LED unit 60. A plurality of fins 515 radially extend from an outer circumferential surface of the heat dissipating portion 51 to dissipate heat of the heat dissipating portion 51. A plurality of inner threads 531 are formed on an inner surface of the extending portion 53 to engage with the connector 30.

The connector 30 is insulating and includes a hollow, cylinder-shaped joining portion 31 and a baffling portion 33. The baffling portion 33 is annular, and protrudes outwards from a middle of an outer circumferential surface of the joining portion 31. That is, the outer diameter of the baffling portion 33 is larger than that of the joining portion 31. Preferably, the outer diameter of the joining portion 31 is slightly larger than an inner diameter of the holder 10, while the outer diameter of the baffling portion 33 is quite larger than the inner diameter of the holder 10 and the inner diameter of the extending portion 53. A bottom end of the joining portion 31 is received in the top end of the holder 10 and interferes with the protruded points 15, thereby fixedly connecting the connector 30 and the holder 10 together. A plurality of outer threads 311 is formed on an outer surface of a top end of the joining portion 31, and threadedly engages with the inner threads 531 of the extending portion 53 of the supporting member 50. After assembled, opposite bottom and top ends of the baffling portion 33 abut against the top end of the holder 10 and a bottom end of the extending portion 53, respectively.

The LED unit 60 includes a disc-shaped printed circuit board 61 and an LED 63 mounted on a central portion of the printed circuit board 61. The printed circuit board 61 is secured on the supporting plate 513 of the heat dissipating portion 51 and thermally contacts with the supporting plate 513.

The lens 70 is made of a light permeable material and includes a convex portion 71 and a light guiding portion 73 extending outwardly from a periphery of the convex portion 71. The convex portion 71 is located at a central portion of the lens 70 and covers the LED 63 of the LED unit 60. A bottom surface of the convex portion 71 facing the LED 63 is convex, and a top surface of the convex portion 71 is also convex. A curvature of the bottom surface of the convex portion 71 is smaller than that of the top surface of the convex portion 71.

The light guiding portion 73 has a shape of a cone. A top end of the light guiding portion 73 is larger than a bottom end of the light guiding portion 73. Two spaced, arc-shaped legs 75 extend downwardly from opposite sides of the bottom end of the light guiding portion 73. The two legs 75 clasp opposite sides of the LED 63 and sandwich the LED 63 therebetween. Thus, the lens 70 and the LED module 60 are assembled together. Bottom ends of the legs 75 abut against the printed circuit board 61. An annular flange 77 extends outwards from a periphery of the top end of the light guiding portion 73 to engage with the pressing ring 80.

The pressing ring 80 is a metallic, annular sheet. An inner edge of the pressing ring 80 presses downwardly the flange 77 of the lens 70. An outer edge of the pressing portion 80 presses downwardly and secured on the top end of the heat dissipating portion 51. Thus, the lens 70 is secured between the pressing portion 80 and the supporting plate 513 of the supporting member 50. The outer surface of the convex portion 71 extends through the pressing portion 80 and is exposed to an outside of the LED lamp. Light of the LED unit 63 travels through convex portion 71 of the lens 70 to lighten to the outside of the LED lamp.

When the LED 63 operates to give off light, heat is accordingly produced. The heat generated by the LED 63 is transferred to the supporting plate 513 and then to the heat dissipating portion 51 and the fins 515 to dissipate into surrounding air. Thus the heat of the LED 63 can be quickly removed, thereby significantly improving lifespan of the LED 63. Further, since the LED 63 is a highly efficient light source with a high brightness, a long lifespan, and a wide color range, the LED lamp with the LED 63 functioning as light source is energy-saving and environment-friendly.

It is to be understood, however, that even though numerous characteristics and advantages of the disclosure have been set forth in the foregoing description, together with details of the structure and function of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. An LED lamp comprising:
a connecting member adapted for electrically connecting with a power source; and
an LED module being threadedly engaged with and electrically connected to the connecting member.

2. The LED lamp of claim 1, wherein the connecting member comprises a connector and a holder, one end of the connector is received in the holder and another end of the connecting portion threadedly engaged with the LED module.

3. The LED lamp of claim 2, wherein a baffling portion is formed on a middle of an outer surface of the connecting portion, and abuts against the holder and the LED module at two opposite ends thereof.

4. The LED lamp of claim 2, wherein the LED module includes a supporting member and an LED unit received in the supporting member, the LED unit electrically connecting with the holder.

5. The LED lamp of claim 4, wherein the supporting member comprises a supporting plate on which the LED unit is arranged, a heat dissipating portion extending upwards from the supporting plate and surrounding the LED unit, and a hollow extending portion extends downwardly from the supporting plate, a plurality of inner threads being formed on an inner surface of the extending portion, a plurality of outer threads being formed on an outer surface of the connector of the connecting member and threadedly engaged with the inner threads of the extending portion.

6. The LED lamp of claim 4, wherein a plurality of fins extend outwardly from the heat dissipating portion for increasing a heat exchanging area of the heat dissipating portion.

7. The LED lamp of claim 4, further comprising a lens received in the heat dissipating portion and covering the LED unit.

8. The LED lamp of claim 7, wherein the lens comprises a convex portion and a light guiding portion extending outwardly from a periphery of the convex, the convex portion aligning with the LED unit.

9. The LED lamp of claim 8, wherein two spaced, arc-shaped legs extend downwardly from opposite sides of the bottom end of the light guiding portion, and clasp opposite sides of an LED of the LED unit and sandwich the LED therebetween.

10. The LED lamp of claim 9, further comprising a pressing ring pressing the light guiding portion and secured on the heat dissipating portion.

11. The LED lamp of claim 10, wherein an outer surface of the convex portion of the lens extends through the pressing portion.

12. The LED lamp of claim 11, wherein the convex portion has an inner convex side near the LED and an outer convex side away from the LED, and a curvature of the inner convex side is smaller than that of the outer convex side.

13. The LED lamp of claim 2, wherein the one end of the connector is securely received in the holder by an interference fit between the connector and the holder.

14. The LED lamp of claim 8, wherein the light guiding portion has a shape of a cone.
